(19) United States
(12) Patent Application Publication
(10) Pub. No.: US 2021/0093101 A1
(43) Pub. Date: Apr. 1, 2021

(54) System for a Presentation, Sales or Exhibition Stand and/or for Store Fitting, as well as Current Collectors for an Electrical Consumer in such a System and its Use

(71) Applicant: MAGNWALL GmbH, Weinstadt (DE)

(72) Inventors: Klaus-Dieter FELD, Weinstadt (DE); Roman STAKHIVSKYI, Stuttgart (DE); Georg BRUGGER, Hardt (DE)

(21) Appl. No.: 17/122,037

(22) Filed: Dec. 15, 2020

Related U.S. Application Data
(63) Continuation of application No. PCT/EP2019/064997, filed on Jun. 7, 2019.

(30) Foreign Application Priority Data
Jun. 28, 2018 (DE) 10 2018 115 659.6

(51) Int. Cl. A47F 5/08; E04H 1/12; G09F 13/02

(52) U.S. Cl. CPC A47F 5/0807; G09F 13/02; E04H 1/1272

(57) ABSTRACT

The present disclosure relates to a system for a presentation, sales or exhibition stand and/or for store fitting, the system comprising a current-carrying wall member and a current collector for an electrical device, which is configured to be mounted on the wall member; wherein the wall member comprises a carrier plate and a cover that covers the carrier place; wherein the wall member comprises first electrical conductor tracks of a first polarity and second electrical conductor tracks of a second polarity, wherein the first and second electrical conductor tracks are arranged alternately at least in sections; wherein the current collector comprises a plurality of at least three contact needles, wherein the current collector is adapted to be attached to the wall member such that at least one of the contact needles contacts one of the first electrical conductor tracks and at least another of the contact needles contacts one of the second electrical conductor tracks; and wherein a first contact needle, a second contact needle, and a third contact needle of said plurality of contact needles are arranged on a circle. The present disclosure further relates to a corresponding current collector and corresponding method.

### CROSS-REFERENCE TO RELATED APPLICATIONS

This is a continuation application of co-pending international patent application PCT/EP2019/064997, filed Jun. 7, 2019 and designating the United States, which was published in German as WO 2020/001959 A1, and claims priority to German patent application DE 10 2018 115 659.6, filed Jun. 28, 2018, each of which are incorporated herein by reference in their entireties.

### BACKGROUND OF THE INVENTION

### Field of the Invention

The present invention relates to a system or presentation system, in particular for a presentation, sales or exhibition stand and/or for store fitting as well as a current collector for an electrical device. The proposed presentation system may also be used in museums or in the field of smart home.

### Related Prior Art

A presentation or exhibition stand is the first point of contact for a new customer and therefore particularly important as a figurehead for the company presenting itself. For this reason, the visual impression and also the options for different and in particular flexible presentations are increasingly important. As a special eye-catcher on wall, floor or ceiling members of presentation, exhibition or sales stands, but also in shop-fitting, special electrical devices such as lighting equipment or monitors etc. are increasingly used to direct the viewer's attention to certain elements. However, in the state of the art the arrangement of such lighting equipment or generally electrical devices requires electrical wiring, which greatly limits the flexibility regarding a variable arrangement of the electrical device or lighting equipment. In the same way, an attractive presentation is of increasing importance in store fitting.

DE 10 2011 005 735 A1 discloses a system for a presentation, sales or exhibition stand and/or for store fitting comprising at least one wall, floor or ceiling member having a carrier material and a cover covering the same, wherein electrical conductor tracks are provided on the carrier material or arranged on/in the cover and wherein the carrier material and/or the electrical conductor tracks can be magnetized, i.e. have ferromagnetic properties; and comprising at least one electrical device which can be attached to the carrier material by means of at least one magnet, wherein the electrical device comprises needle-shaped current collectors which penetrate the cover when the electrical load is attached to the carrier material and thereby make electrical contact with the conductor tracks and supply the electrical device with current.

The system known from DE 10 2011 005 735 A1 makes it possible to provide a wall member, for example for a presentation, sales or exhibition stand or for store fitting, which in particular enables an easily changeable and therefore flexible arrangement of electrical devices on the wall member.

DE 10 2013 011 329 A1 discloses a display stand and a method for assembling a display stand. The display stand has a presentation wall and at least one object held on it, wherein the presentation wall and the object have interacting latching contours on abutting, which allow the object to be held on the presentation wall in a plurality of different, pre-defined positions; the object being held on the presentation wall by magnetic forces; the latching contours are designed such that the smallest possible distance between mutually displaces latching positions of the object is smaller than the extension of the contact surface of the object measured in the displacement direction; and at least in a part of the possible positions of the object on the presentation wall, a direct power supply of the object through the contact surfaces is provided via the presentation wall.

DE 10 2011 075 460 A1 discloses a further refinement of the aforementioned mentioned solution, in which the energy transmission can now be effected by induction instead of using conductor tracks and needle-shaped current collectors.

For example, the wall member comprises a transmitting device for the wireless transmission of electrical energy and/or for the wireless transmission of data, in particular by means of induction. Correspondingly, the electrical consumer device comprises a corresponding receiving device for wireless reception of electrical energy and/or wireless reception of data from the transmitting device, in particular by means of induction. This is intended to achieve a freely selectable and flexibly variable arrangement of the electrical consumer device on the wall member without damaging the cover.

### SUMMARY OF THE INVENTION

Against this background, it can be among others an object of the present disclosure to provide a system for a presentation, sales or exhibition stand and/or for store fitting, which allows in a simple way a freely selectable and flexibly changeable arrangement of an electrical consumer device on a wall member. In particular, it would be desirable to enable a more flexible positioning compared to DE 10 2011 005 735 A1 and to provide a more cost-effective solution compared to DE 10 2011 075 460 A1.

According to a first aspect of the present disclosure, a system, in particular for a presentation, sales or exhibition stand and/or for store fitting, is proposed, the system comprising:
a current-carrying wall member and
a current collector for an electrical device (electrical consumer device), which is configured to be mounted on the wall member;
wherein the wall member comprises a carrier plate and a cover (covering) that covers the carrier plate;
wherein the wall member comprises first electrical conductor tracks (of a first polarity) and second electrical conductor tracks (of a second polarity), wherein the first and second electrical conductor tracks are arranged alternately at least in sections;
wherein the current collector comprises a plurality of at least three contact needles,
wherein the current collector is adapted to be attached to the wall member such that at least one of the contact needles contacts one of the first electrical conductor tracks and at least one other of the contact needles contacts one of the second electrical conductor tracks; and
wherein a first contact needle, a second contact needle, and a third contact needle of said plurality of contact needles are arranged on a circle.

According to a second aspect of the present disclosure, a corresponding current collector for an electrical consumer (for use) in a system for a presentation, sales or exhibition stand and/or for store fitting is proposed.

According to a further aspect of the present disclosure, the use of such a current collector in such a system is proposed for a presentation, sales or exhibition stand and/or for store fitting.

According to a further aspect, a corresponding method is proposed for or for the equipping of a presentation, sales or exhibition stand and/or for store fitting.

The inventors recognized that the solution disclosed in DE 10 2011 005 735 A1 enables a substantially free positioning in a horizontal and vertical direction on current-carrying wall member. However, with conventional needle connectors, there is the problem that the rotation of the current collector relative to the current-carrying wall member can cause both contact needles to come to rest on the same electrical conductor track. For example, a current collector or an electrical consumer comprising a current collector cannot simply be rotated by 90°. It would thus be desirable to further improve the positionability and to still establish an electrical contact even with different angular orientations.

The inventors recognized that the solution proposed in DE 10 2011 075 460 A1 for the wireless transmission of electrical energy offers a solution to this problem and allows a substantially flexible positioning of electrical devices on a wall member. In this case, it is also possible to rotate consumer devices or current collectors relative to the wall member. However, the effort and the costs for an large area wireless energy supply are relatively high. Furthermore a wireless energy supply has a relatively low efficiency.

In accordance with an aspect of the present disclosure, it is therefore proposed that the current collector comprises not only two contact needles but a plurality of at least three contact needles and wherein a first contact needle, a second contact needle, and a third contact needle of the plurality of contact needles are arranged in such a way that they lie on a circle or arc of a circle. Due to the proposed arrangement of the contact needles on a circle arc, in addition to a relatively free positioning, e.g. in horizontal and/or vertical direction, an additional degree of freedom can be created, which can enable a freer rotation.

With the proposed solution, the probability that at least one of the contact needles contacts one of the first electrical tracks and at least one other of the contact needles contacts one of the second electrical tracks can therefore be increased. In other words, the contact of at least two contact needles with the respective tracks of different polarity can be maintained longer upon rotation. Further measures to enable a substantially free rotation are explained in the examples below.

The proposed solution is based on the general idea that a current-carrying wall serves as the source and an adapter or current collector is provided to tap electricity from the wall. The wall member can be adapted to be connected to a current or voltage source such as a power supply. The first electrical tracks can be connected to a positive pole and the second tracks to a negative pole. For example, a DC voltage of 12V or 24V can be provided. Alternatively, a different type of power supply, such as an AC voltage or a DC voltage with a superimposed AC voltage can be provided via the first and second conductive tracks. The wall member can have a carrier plate and optionally a cover that covers it. The combination of carrier plate and cover is especially advantageous for such presentation stands, because a cover can be changed quickly and the stand can be easily adapted. For example, such a cover can be printed and/or labeled. The current collector and/or the electrical device can be adapted to be mounted on or attached to the wall member.

The conductor tracks of the electrical wall member can be an integral part of the carrier element, for example in the form of a punched steel plate, and can be arranged on the carrier material and/or on or in the cover. It shall be understood that a wall member may also have a layered structure. Such a layered structure can have one or more of the following layers: a support structure, such as wood or metal, a layer of a magnetic or magnetizable material, such as steel, an insulation layer, and a conductor track layer, e.g. of a (thin) metal foil. For example, a carrier plate or support structure, e.g. made of plastic, may be provided, on which a layer of a magnetic or magnetizable material, e.g. steel, is applied, which may optionally be adapted as a first and/or second conductor track at the same time, and optionally a cover can be provided. The use of a layer of a magnetic or ferromagnetic material is advantageous, because a current collector or consumer can be flexibly attached to the wall member with magnets.

The current collector comprises a plurality of at least three contact needles. The current collector is adapted to be mounted on the wall member in such a way that at least one of the contact needles contacts one of the first electrical tracks and at least one other of the contact needles contacts one of the second electrical tracks. For example, in the case where the conductive tracks are arranged on the carrier plate of the wall member and the wall member has a cover that covers the carrier plate, the contact needles may be adapted to penetrate the cover and make an electrical connection with the respective conductive tracks. The contact needles can pierce through or into the wall member. Of course, it is also possible that the electrical conductors are integrated into the cover, in particular woven into it. Basically, the current collector can be adapted to establish an electrical connection with the first and the second conductor track when placed on the wall member and to supply the tapped voltage to a consumer or load device.

Advantages of the proposed solution in comparison to conventional store or trade fair construction may in particular that a complex cabling of the individual electrical devices attached to the presentation element can be omitted. Instead, the consumer devices can be flexibly attached to the presentation element on-the-fly. Expensive corrections can thus be omitted. In addition, creativity can be promoted, since the individual consumers can be flexibly repositioned and aligned, especially also with regard to their rotation relative to the wall member. In a way, such a system invites to play and experiment with the arrangement of the electrical consumer devices in order to achieve the most appealing presentation result. In particular, the current-carrying wall member can be charged with electricity even before the consumers are attached and the result can be assessed immediately. A time-consuming new wiring is not necessary.

It is to be understood that the current collector can either be attached as such to the wall member and the tapped current can, for example in a wired manner, be fed to a consumer device, or the current collector can be integrated into a holder or integrated in an electrical consumer device.

A system for a presentation, sales or exhibition stand and/or for store fitting can also be referred to as a display or show stand. A wall member in the context of the present disclosure can also refer to a floor element or a ceiling element. In the context of the present disclosure, a contact needle can also refer to a contact pin or contact stick, which does not necessarily have a pointed tip. The contact needles can be arranged in such a way that these or the tips or ends of the contact needles lie in one plane. Optionally, the contact needles can be spring-loaded. The contact needles can be adapted to penetrate the cover. In the context of the present disclosure, an equilateral or equilateral triangle can optionally be understood to be a triangle in which the lengths of the legs or sides do not differ by more than 20%, preferably by more than 10%, preferably by more than 5% each relative to one of the other legs or sides.

Alternatively or in addition to the above arrangement of the first, second and third contact needles, the first, second and third contact needles may be arranged in such a way that a first straight line through the first and second contact needles and a second straight line through the second and third contact needles intersect at an (acute) angle.

The first, second and third contact needle of the current collector can be arranged in such a way that they form a triangle, in particular an acute-angled triangle. An acute-angled triangle is a triangle in which all angles are smaller than 90°. The three sides can, but do not have to be of different lengths.

The first, the second and the third contact needle of the current collector can be arranged in such a way that they form an isosceles, in particular an equilateral triangle.

The inventors recognized that a triangular arrangement of the first, second and third contact needles lying on the circle or circular arc, in particular for an arrangement as an approximately equilateral triangle, allows a more flexible positioning, in particular with regard to a rotation of the current collector on the wall member.

A diameter of the circle on which the first contact needle, the second contact needle and the third contact needle are located can be smaller than or equal to the sum of a width of one of the first conductor tracks and a width of one (adjacent) of the second conductor tracks, and optionally a gap between them. An advantage of this solution may be that when the current collector is rotated, different contact needles on the first or second conductor track come to rest on and enable contact of at least two contact needles on different conductor tracks over a larger angular range.

The contact needles of the current collector can be arranged in such a way that, when the current collector is attached to the current-carrying wall member, at least a first of the contact needles (lying on the circle) can be brought into contact with one of the first conductor tracks and a second contact needle (lying on the circle) can be brought into contact with one of the second conductor tracks, independently of a rotation (or alignment) of the current collector (in the plane of the circle or plane of the wall member) on the current-carrying wall member. It shall be understood that the contacting may not to be understood completely independent of rotation, but within the scope of the present disclosure as substantially independent of rotation, e.g. taking into account a tolerance of +−5° or +−10°, so that a contact needle does not fall in a gap between two adjacent conductor tracks. Such a gap may be provided to avoid a short circuit between two adjacent conductor tracks.

In other words, the contact needles of the current collector can preferably be arranged in such a way that, independently of a rotation of the current collector on the wall, at least one of the contact needles makes a connection with one of the first conductor tracks (e.g. the positive pole) and at least one other of the contact needles makes a connection with one of the second conductor tracks (e.g. the negative pole). Thus, an electrical power supply of a device via the proposed current collector can be made possible over a wide angular range.

The contact needles lying on a circle can be arranged in such a way that the first contact needle lies in a first third of the circle, the second contact needle lies in a second third of the circle and the third contact needle lies in a third third of the circle. For example, the circle can be divided into three circle segments of equal size and one of the three contact needles can be located in each of the three circle segments.

The current collector may further comprise a fourth, fifth and sixth contact needle. The first to sixth contact needle can be arranged as a hexagon. In particular, the contact needles can be arranged as a hexagon, in particular as an equilateral hexagon or star, with the contact needles forming the corners of the hexagon or the tips of the star respectively. However, it shall be understood, that a different number of contact electrodes may be provided, in particular four or more, five or more, six or more, seven or more, or eight or more.

The current collector and the contact needles may be arranged such that, when the current collector is attached to the wall member, at least two contact needles contact one or more of the first electrical conductor tracks and at least two of the contact needles contact one or more of the second electrical conductor tracks. This can be particularly advantageous for applications with high power consumption. Usually a current collector with 3 or 4 contact needles is sufficient for currents up to 2 A. However, a higher number of contact needles can be advantageous as the current per current collector can be reduced. For example, cheaper components may be used. For example, two standard diodes each for 2 A may be cheaper than a high-power diode designed for 4 A. Alternatively, several current collectors can be used in parallel to tap a required power. Experiments have shown that besides the supply of lamps also the supply of displays is feasible. With a combination, such as a parallel connection of several current collectors, outputs of up to 3,000 watts or more are generally feasible.

The contact needles can be arranged such that a distance between the first contact needle and a straight line through the second contact needle and the third contact needle is greater than a width of one of the electrical conductor tracks. In the alternative or in addition, a distance between the first contact needle and a straight line through the second contact needle and the third contact needle can be smaller than twice the width of one of the electrical conductor tracks, and optionally an insulation gap between them. An advantage of this arrangement may be that rotation is possible over a wide angular range.

The current collector may comprise a fourth contact needle and the fourth contact needle may be arranged within the circle on which the first, the second and the third contact needles are arranged. For example, the fourth contact needle may be arranged on a center of a circle or on a center of a triangle formed by the first, second and third contact needles. An advantage of this embodiment can be that it further improves the probability of enabling a sufficient electrical connection of the current collector to the conductors. For example, the problem that two of the three contact needles lying on the circle may fall into an insulation gap between one of the first tracks and one of the second tracks can be addressed. In an advantageous refinement, the fourth contact needle can be arranged decentered at a distance from a center of the circle. It shall be understood that also the features of this embodiment can be combined with the features of one or more of the previous or following embodiments. A “fourth” contact needle can be understood as a further contact needle. For example, a fourth contact needle in the above mentioned arrangement as a hexagon can be understood as a first fourth contact needle and a fourth contact needle which is arranged within the circle according to the present example can be understood as a second fourth contact needle or further contact needle. It shall be understood that this second fourth contact needle or further contact needles can be arranged within a circle on which the first, second and third contact needles are arranged, but on which also further contact needles can be arranged.

The system may also comprise a rectifier. The rectifier may be adapted to provide an output voltage of defined polarity based on an input voltage applied to at least two of the contact needles. The rectifier can be part of the current collector, a separate element or part of the electrical device. For example, a bridge rectifier can be provided. In addition or in the alternative, the rectifier can be arranged in a device that can be connected to the current collector. The rectifier may comprise a first output contact and a second output contact. In order to limit the complexity of the circuitry and thus the costs of the rectifier, the current collector may preferably comprise exactly four or exactly three contact needles. In particular with exactly four contact needles an advantage is the limited circuit complexity and the possibility to cover large angle ranges.

In a further refinement, the rectifier may have at least three inputs and (exactly) two outputs, whereby each of the at least three inputs is connected to a respective contact needle.

The current collector (optionally in combination with a holder) can be adapted such that the contact needles are movable between a contact position, in which the contact needles contact the conductive electrical tracks, and a non-contact position, in which the contact needles are separated from the tracks when the current collector is attached to the current-carrying wall member. Here the non-contact position can also be called a shifting position or moving position. Preferably, the current collector can be moved on the wall member to reach a desired position. When the desired position is reached, the contact needles can be lowered or brought into the contact position. In an example the current collector may comprise a holder, whereby the holder is adapted in such a way that the contact needles are brought into contact with the tracks by inserting, for example by sliding in, a device into the holder. For example, the contact needles are only activated when a connecting element is inserted or when a consumer device or housing is inserted or attached. An advantage can be an improved positionability in the non-contact position.

The current collector may be adapted such that, when the current collector is aligned horizontally or vertically (on the wall member), a straight line through the first and second contact needle intersects a horizontal or vertical axis of the current collector at an acute angle, in particular at an angle of not more than 30°, in particular at an angle of not more than 15°, in particular at an angle of not more than 5°.

Alternatively or additionally, the system may in an embodiment further comprise an electrical device (also referred to as consumer device), on which the current collector is arranged in such a way that a straight line through the first and the second contact needle intersects a horizontal or vertical axis of the electrical device at an acute angle, in particular at an angle of not more than 20°, in particular at an angle of not more than 10°, in particular at an angle of not more than 5°, when the electrical consumer is oriented horizontally or vertically (on the wall member).

In other words, the arrangement of the contact needles can be rotated by an (acute) angle relative to the orientation of the conductor tracks. The relative position of the contact needles and housing must be taken into consideration. An advantage of this solution can be an improved reliability in contacting. The inventors recognized that especially in store fitting, elements which are attached to the wall member are preferably mounted horizontally or vertically aligned. Furthermore, angles in the range between 25 and 65° are frequently used. Minor rotations, for example by 5° or 10° with respect to the horizontal or vertical, are more likely to be perceived as undesired tilting or misalignment. By choosing exactly such a rarely occurring angle, the probability that two contact needles lying on a line may coincide with an insulation gap between two adjacent electrical conductor tracks can be reduced.

At least one (but preferably all) of the contact needles may be adapted such that a tip of the contact needle has an angle between 60° and 20°, in particular between 45° and 25°, in particular of 30°. For an angle specified as 30°, a tolerance of ±10°, in particular ±5, may be allowed. An advantage of this embodiment can be a good penetration of the optional covering cover and a sufficient contact area while providing sufficient conductivity at the same time.

The wall member and the current collector can be arranged such that the current collector can be magnetically attached to the wall member. Alternatively, other fastening means or types of fastening, such as gluing or screws, can be used. However, the use of a detachable connection is preferred to enable subsequent design variations.

Advantages described above in detail for the first aspect of the present disclosure may apply accordingly to the further aspects of the present disclosure.

It shall be understood that the features mentioned above and the features to be explained below can be used not only in the combination indicated in the respective embodiment, but also in other combinations or on their own, without leaving the scope of the present invention.

### BRIEF DESCRIPTION OF THE DRAWINGS

Exemplary embodiments of the present disclosure are illustrated in the drawings and will be explained in more detail in the following description.

FIG. 1 shows an exemplary presentation stand with a system according to an embodiment of the present disclosure with several wall members;

FIG. 2 shows a schematic illustration of a wall member without cover;

FIG. 3 shows a schematic illustration of a wall member with cover;

FIG. 4 shows a side view of a current collector attached to a wall member;

FIG. 5 shows an enlarged view of the current collector of FIG. 4;

FIG. 6 shows a first exemplary illustration of an arrangement of contact needles on a current collector;

FIG. 7 shows a second exemplary illustration of an arrangement of contact needles on a current collector;

FIG. 8 shows a third exemplary illustration of an arrangement of contact needles on a current collector;

FIG. 9 shows a fourth exemplary illustration of an arrangement of contact needles on a current collector;

FIG. 10 shows an illustration of arrangements of contact needles on a current-carrying member in different positions and rotations

FIG. 11 shows a further illustration of different arrangements of contact needles on a current-carrying wall member in different positions and rotations

FIG. 12 shows an arrangement of three contact needles in combination with a rectifier;

FIG. 13 shows an arrangement of four contact needles in combination with a rectifier;

FIGS. 14A to C show a top view as well as first and second side views of a current collector for an electrical device;

FIG. 15 shows a perspective view of an exemplary current collector;

FIG. 16 shows a perspective view of an exemplary current collector with a magnetic holder;

FIG. 17 shows a flowchart of a method

### DETAILED DESCRIPTION OF EXEMPLARY EMBODIMENTS

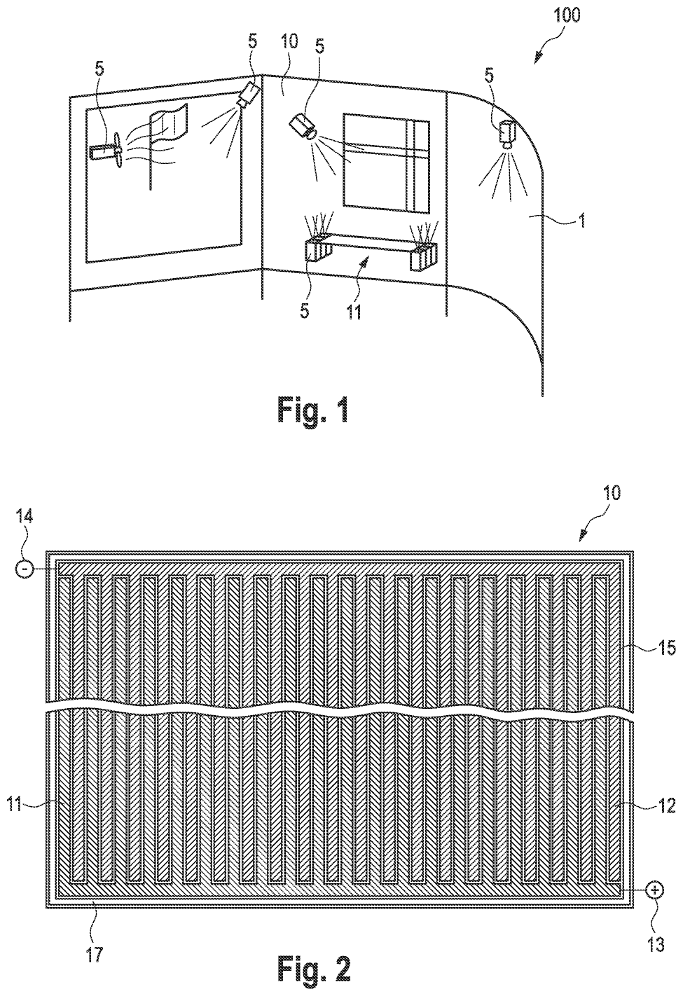

FIG. 1 shows an exemplary presentation stand 100 or a shop window construction with a system according to an embodiment of the present disclosure. The presentation stand 100 comprises a plurality of wall members 10. Various objects 5 can be attached to the wall members 10. For this purpose, various fasteners known from store fitting or trade fair construction can be used. In a preferred embodiment, the objects can be magnetically attached to the wall members 10. An advantage of this solution is that the objects 5 can be positioned freely on the wall members 10. It shall also be understood that corresponding floor or ceiling elements can be provided, which are also referred to as wall members in the context of the present disclosure for the sake of simplicity. The objects may be electrical devices 5, such as a light source, lighting equipment, a screen, a motor, a loudspeaker, a mannequin or the like. For the power supply, current collectors are provided which are electrically connected to the electrical consumers 5 or can be configured as part of the objects or electrical devices.

With the proposed wall member 10 and the associated current collector 20, presentation, sales or exhibition stands 100, especially in modern showrooms, can be easily modified and, in particular, easily adapted to local conditions, thus providing a high degree of flexibility with regard to the design freedom of the presentation, sales or exhibition stand 100. Such wall members 10 can also be used in store fitting. Furthermore, the system can advantageously also be used in museums or in the smart home sector.

Compared to conventional exhibition stands, there is no need for complex wiring of electrical devices, which not only simplifies assembly and disassembly considerably, but also allows the electrical consumers to be positioned almost freely and variably. For the construction of the presentation, sales or exhibition stand 100, several wall members 10 are typically assembled.

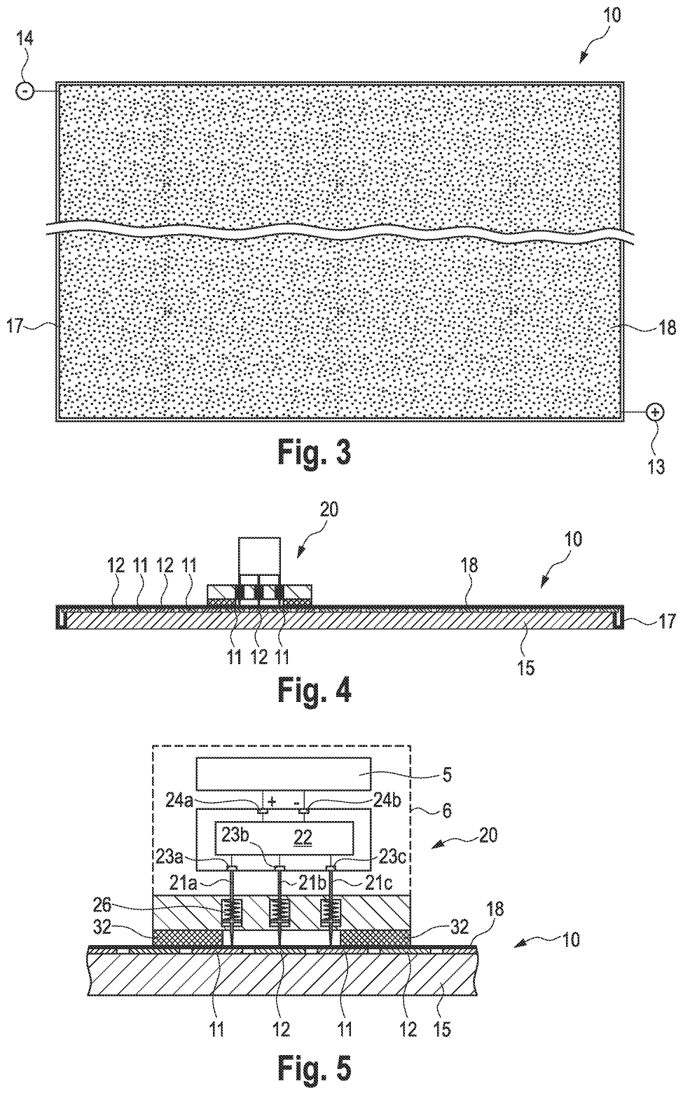

A peculiarity of the proposed system is that the current collectors 10 or the electrical consumers 5 can not only be flexibly positioned on the wall members 1 with regard to their horizontal and vertical position, but that rotation can also be enabled. For this purpose, the proposed system comprises at least one current-carrying wall member 10 and a current collector 20 for an electrical device 5. An embodiment of a current-carrying wall member 10 is shown in FIGS. 2 and 3. Exemplary embodiments of current collectors are shown in FIG. 4 ff.

FIG. 2 shows a schematic illustration of a wall member 10 without cover. The wall member 10 comprises first electrical conductor tracks 11 of a first polarity and second electrical conductor tracks 12 of a second polarity. The first and second electrical conductors 11, 12 are arranged alternately at least in sections. The first electrical conductors 11 can form a first comb-like structure. The second electrical conductors 12 can form a second, corresponding comb-like structure, whereby the first comb-like structure and the second comb-like structure are formed such that the comb-like structures engage in one another. An insulation gap is provided between the first and second electrical conductors 11, 12. The insulation gap ensures that no short circuit occurs. Preferably, the width of the insulation gap should be as small as possible, for example less than 2 mm, in particular less than 1.5 mm, in particular less than 1.0 mm, in particular less than 0.5 mm, in particular less than 0.2 mm. The width of the isolation gap can be smaller than 1/10, especially smaller than 1/20 of a conductor track width. This can reduce the probability of one of the contact needles falling into the isolation gap. However, the insulation gap can be larger than a width of a tip of a contact needle of a current collector to avoid a short circuit between the conductive electrical tracks of the first polarity 11 and the conductive electrical tracks of the second polarity 12. The conductor tracks 11 of the first polarity are adapted to be connected to a first output of a voltage source, e.g. a positive pole 13. The conductor tracks 12 of the second polarity are adapted to be connected to a second output of a voltage source, for example a negative pole 14. Instead of a DC voltage, the conductor tracks 11, 12 can also be supplied with an AC voltage or a combination of DC and AC voltage. An area of the current-carrying wall member can be covered by at least 70%, in particular by at least 85%, in particular by at least 90% or 95% with the first and second conductor tracks. The conductor tracks 11, 12 can be part of a carrier element 15 of the wall member 10 or alternatively be applied on the carrier element 15.

FIG. 3 shows a schematic illustration of a wall member 10, which comprises an optional cover 18. For example, the cover 18 can cover the electrical conductor tracks 11, 12 applied to the carrier plate 15. Alternatively, the conductor tracks 11, 12 can be part of the cover. In this case, the conductor tracks may have the same or similar geometry as the conductor tracks described above and shown in FIG. 2. To attach the cover 18 to the wall member 10, a piping rail 17 (or a piping profile) can be provided at the edge, into which e.g. a piping strip on the cover side can be inserted. The piping rail can be made of silicone or aluminum, for example.

FIG. 4 shows a side view of a system comprising a wall member 10 and a current collector 20 attached to the wall member 10. FIG. 5 shows an enlarged view of the current collector 20 from FIG. 4 on the wall member 10. The wall member 10 comprises a carrier plate 15 and optionally a cover 18 covering it. The wall member 10 also comprises first electrical conductor tracks 11 of a first polarity and second electrical conductor tracks 12 of a second polarity, the first and second electrical conductor tracks 11, 12 being arranged alternately at least in sections.

The current collector 20 comprises a plurality of at least three contact needles 21a, 21b, 21c. The current collector 20 is adapted to be mounted on the wall member 10 such that at least one of the contact needles 21a contacts one of the first electrical conductor tracks 11 and at least one other of the contact needles 21b contacts one of the second electrical conductor tracks 12. Here, a first contact needle 21a, a second contact needle 21b, and a third contact needle 21c of the plurality of contact needles can be arranged such that they are arranged on a circle, as explained in more detail with reference to FIG. 6 ff. below.

To attach or mount the current collector20 to the wall member 10, the wall member 10 and the current collector 20 can be adapted such that the current collector can be magnetically attached to the wall member. For example, the current collector 20 may comprise one or more magnets 32 as shown in FIGS. 4 and 5. The electrical conductor tracks 11, 12 and/or the carrier plate may comprise a magnetic material so that the current collector can adhere to it.

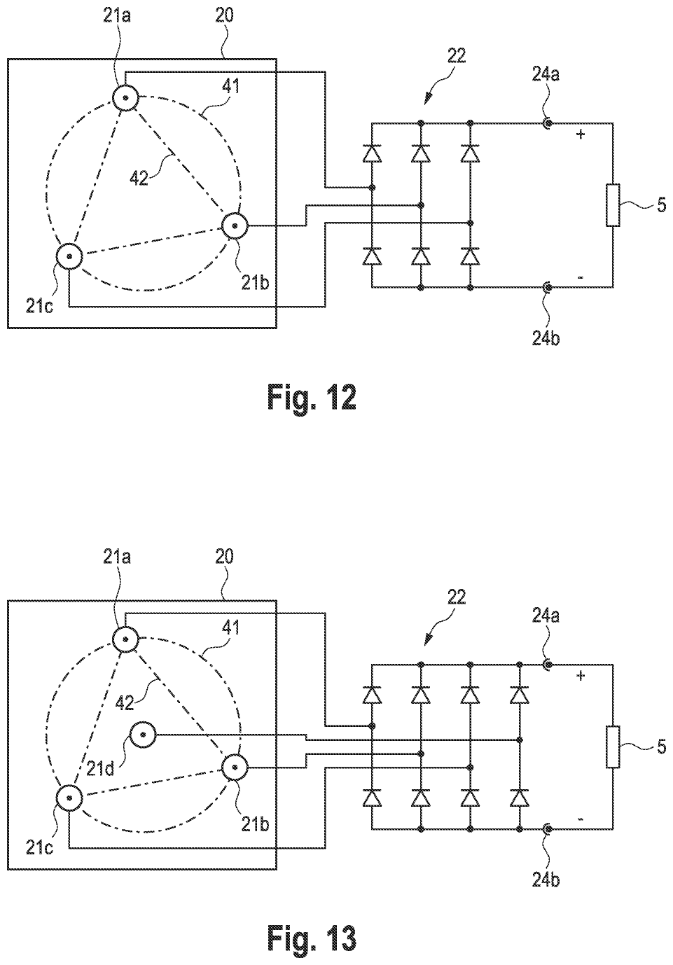

The contact needles 21a-c of the current collector can be connected to a rectifier 22. The rectifier can be part of the current collector or part of an electrical device 5 that can be connected to the current collector. The rectifier 22 is adapted to provide an output voltage of defined polarity based on an input voltage applied to at least two of the contact needles 21a-c. Output pins 24a, 24b can be provided for this purpose, to which an electrical device 5 can be connected. The rectifier may comprise at least three inputs 23a-c and two outputs 24a,b, each of the at least three inputs 23a-c being connected or connectable to a respective contact needle 21a-c. Exemplary embodiments of such rectifiers in the form of bridge rectifiers are shown in FIGS. 12 and 13. Optionally, the rectifier 22, the current collector 20 and the electrical device 5 can form a unit 6. Optionally, the current collector 20 and the rectifier 22 can be part of the electrical device 5.

It shall be understood that the current collector or contact needles can optionally comprise a contact spring 26 for the contact needles, as shown in FIG. 5, so as to provide a defined contact pressure.

FIGS. 6 to 9 show exemplary illustrations of arrangements of contact needles 21a-f on a current collector 20. The current collectors 20 comprise a plurality of at least three contact needles 21a-21f respectively, where a first contact needle 21a, a second contact needle 21b, and a third contact needle 21c of the plurality of contact needles 21a-21f are arranged such that they lie on a circle 41. The circle 41 is shown in dotted auxiliary lines, as this is only serves to describe the type of arrangement.

In the example shown in FIG. 6, the current collector 20 comprises three contact needles 21a-c, wherein the first, the second and the third contact needle 21a-21c of the current collector 20 are arranged such that they form a triangle 42, in particular an acute-angled triangle, in particular an isosceles triangle, and in particular an equilateral triangle.

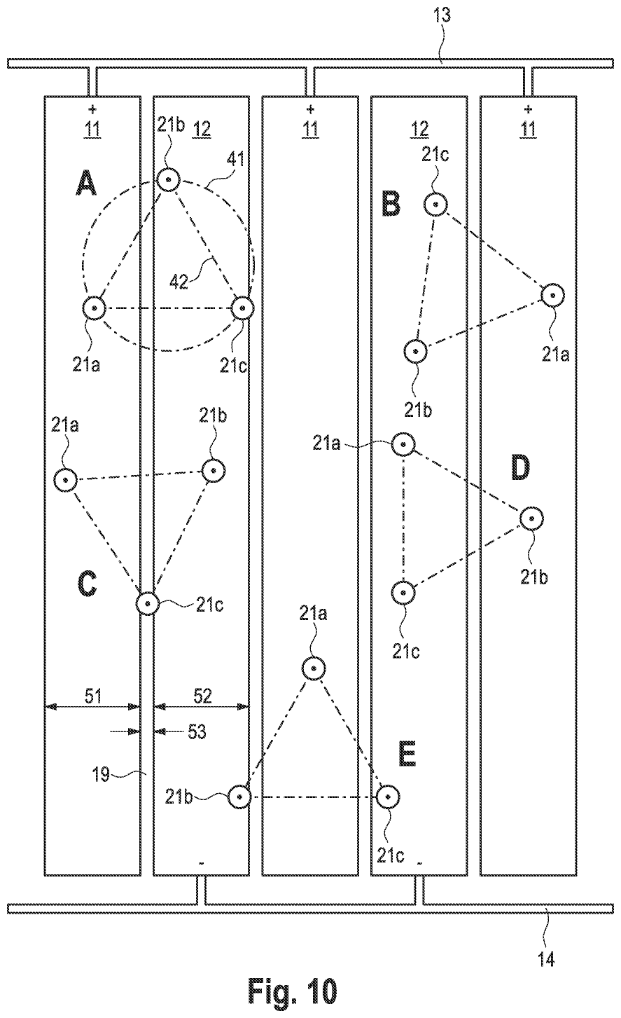

FIG. 10 shows an illustration of the current collector shown in FIG. 6 or respectively its contact needle arrangement in different positions and rotations A to F. In the background, the first electrical conductor tracks 11 and second electrical conductor tracks 12 of the wall member 10 are shown. The current collector 20 (more precisely its contact needle arrangement) is adapted to be attached to the wall member such that at least one of the contact needles 21a contacts one of the first electrical conductors 11 and at least one other of the contact needles 21b, 21c contacts one of the second electrical conductors 12. As can be seen from FIG. 10, even in a plurality of different rotation states, at least one of the contact needles can always be in contact with one of the first electrical conductor tracks 11, here the positive pole, and at least one of the contact needles can be in contact with one of the second electrical conductor tracks 12, here the negative pole. This applies even if, as shown in position C, one of the contact needles 21c lies in an insulation gap 19 between the tracks 11, 12.

Hereby, a diameter of the circle 41 (see FIG. 6), on which the first contact needle, the second contact needle and the third contact needle are arranged, can be smaller than or equal to the sum of a width 51 of one of the first conductor tracks 11 and a width 52 of one of the second conductor tracks 12 and optionally a width 53 of the insulation gap 19 between them. As shown in FIG. 10 at position E, two contact needles 21b, 21c can also lie on different conductor tracks 12 of the same polarity, whereby a third of the contact needles 21a lies on a conductor track 11 of the other polarity. Optionally, the contact needles 21a-c can be arranged such that a distance between the first contact needle 21a and a straight line through the second contact needle 21b and the third contact needle 21c is greater than a width 51, 52 of one of the electrical tracks 11, 12.

The following table shows exemplary combinations of conductive track widths and circle diameters 41, assuming an insulation gap with a width of 1 mm and a contact area of 0.5 mm. The first and second conductive tracks 11, 12 can have the same track width.

| Electrical conductor | Circle diameter d |
|---|---|
| track width in mm | in mm |
| 9 | 16-17 |
| 10 | 17-19 |
| 11 | 18-21 |
| 14 | 22-27 |
| 15 | 24-29 |
| 19 | 29-37 |
| 20 | 30-39 |

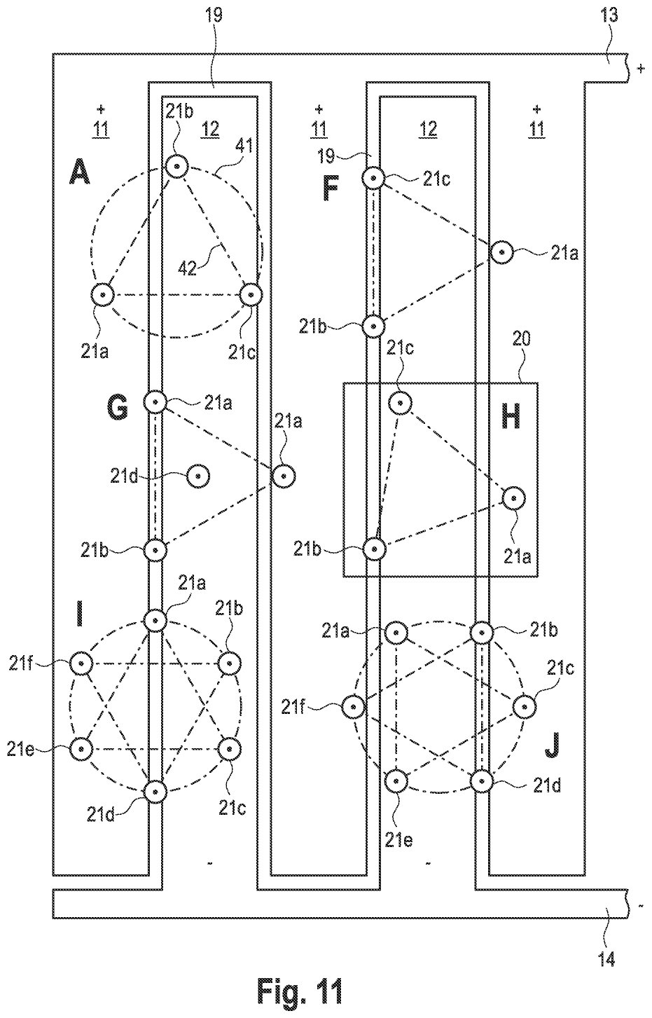

FIG. 11 shows another illustration of different arrangements of contact needles on a current-carrying wall member in different positions and rotations. However, in a particularly unfavorable case, as shown in FIG. 11 position E, for example, the second contact needle 21b and the third contact needle 21c can fall into the insulation gap 19 between the tracks 11, 12. In this special case, a power supply would not be possible without any further action. A first possible solution is to combine a first and a second current collector with different rotational orientations of the contact needles 21a-21c, for example with the orientations shown in FIG. 11 position A and position B. However, this would require a not negligible amount of material.

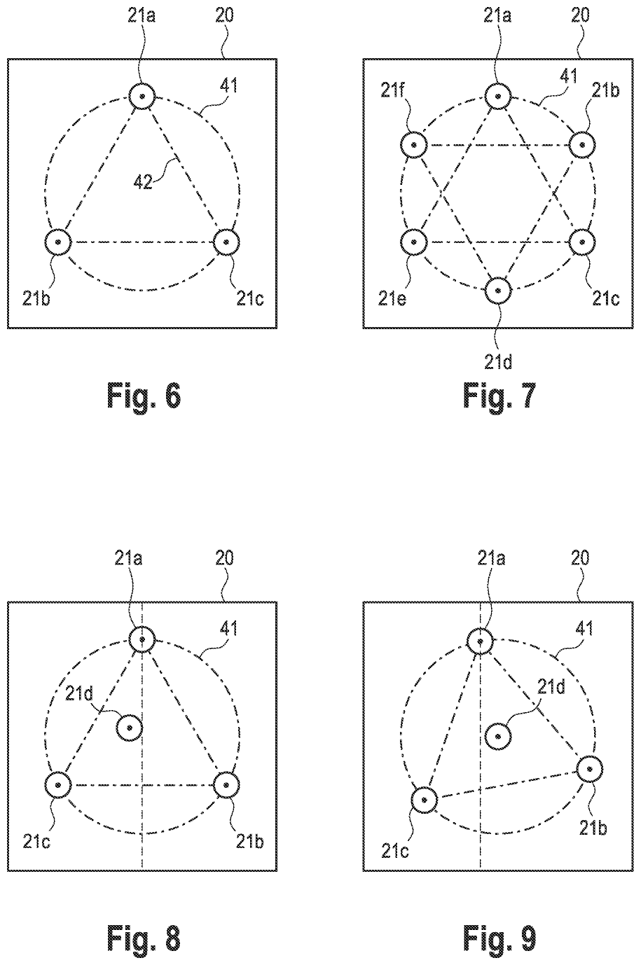

FIG. 11 positions G to J show further exemplary remedies. As shown in FIGS. 8 and 9 and FIG. 11 position G, the current collector 10 can optionally be provided with a fourth contact needle 21d. The fourth or further contact needle 21d can be arranged within the circle 41, on which the first, second and third contact needle 21a-c are located. It shall be understood that such a further contact needle inside the circle can also be provided in combination with further contact needles, as for example shown in FIG. 7. Thereby the flexibility regarding free positioning and rotation of the current collector relative to the wall member can be further improved. In the examples shown in FIG. 9 and FIG. 11 G, the fourth contact needle can be arranged in a center of circle 41 and/or in a center of gravity of triangle 42 (these points coincide for an equilateral triangle).

Optionally, the fourth contact needle 21d can be arranged spaced apart decentered from a center of the circle 41, as shown in FIG. 8. This has the advantage of reducing the probability that, for example, the contact needles 21a and 21d will lie in a straight line 43, which is parallel to a horizontal or vertical axis of the current collector 20. The inventors recognized that the current collectors 20 are often aligned horizontally or vertically. Against this background, it can be advantageous to arrange the positioning of the contact needles turned with respect to a horizontal or vertical axis of the current collector 20, as shown in FIG. 9 and FIG. 11 position H. This can also provide the advantage of reducing the probability that, for example, contact needles 21a and 21d are located on a straight line 43 parallel to a horizontal or vertical axis of the current collector 20. The use of a fourth contact needle 21d is optional. In particular, exactly three contact needles can be provided in this case, so that the costs and the manufacturing effort can be further reduced.

In a further exemplary embodiment the current collector 20 may also comprise a fourth contact needle 21d, a fifth contact needle 21e and a sixth contact needle 21f. The six contact needles 21a-f can be arranged as a hexagon, especially as an equilateral hexagon or star. As shown in the examples in FIG. 11 position I and J, in this case, even if two contact needles 21a and 21d, as shown in FIG. 11 position I, or 21b and 21d, as shown in FIG. 11 position J, fall into the insulation gap 19, an electrical connection can still be established with one of the first electrical conductor tracks 11 and one of the second electrical conductor tracks 12. Another advantage of this embodiment can be that when the current collector 20 is attached to the wall member 10, at least two contact needles 21e, 21f contact one or more of the first electrical conductor tracks 11 and at least two of the contact needles 21b, 21c contact one or more of the second electrical conductor tracks 12. This may allow higher current flows and thus higher power of an electrical device 5 connected to the current collector 20.

FIG. 12 shows an illustration of a current collector 20 with an arrangement of three contact needles 21a-21c in connection with a rectifier 22. FIG. 13 shows a corresponding representation of a current collector 20 with an arrangement of four contact needles 21a-21d in connection with a rectifier 22. In the shown examples, a diode bridge rectifier is shown, but other types of rectifiers can be used. An advantage of this solution is a simple, low-cost design, which is also easily scalable for a larger number of contact needles 21a-f. An output voltage of defined polarity is provided at outputs 24a, 24b, which can be fed to an electrical load 5.

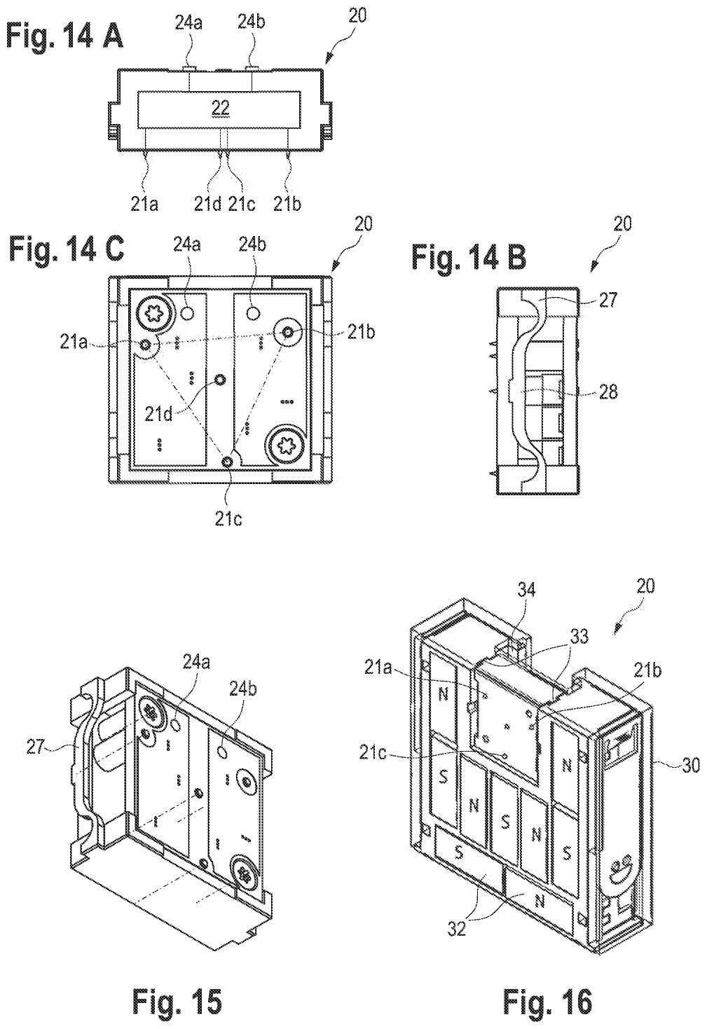

FIG. 14 A to C show a top view (C), as well as a first and a second side view (A, B) of a specific exemplary embodiment of a current collector 20 for an electrical device. FIG. 15 shows a perspective view of this current collector 20. Such a current collector can also be called a needle connector. Here the contact needles 21a-21d can be arranged on a lower side or first side of the housing and the current interfaces 24a, 24b can be arranged on an upper side or second (opposite) side of the housing. For example, the rectifier circuit 20 shown in FIG. 13 may be integrated into the current collector 20. Hence a compact component can be provided that can be handles easily.

In the shown example, the current collector comprises four contact needles, which may for example be arranged similar to the illustration shown in FIG. 9. However, other arrangements or numbers of contact needles may be provided. In particular, the current collector 20 may be adapted such that, with horizontal or vertical alignment of the current collector, a straight line through the first and second contact needles 21a, 21b intersects a horizontal or vertical axis of the current collector at an acute angle, in particular at an angle not exceeding 30°, in particular at an angle not exceeding 15°, in particular at an angle not exceeding 5°.

FIG. 16 shows a perspective view of a current collector 20 with a magnet holder 30. The magnet holder 30 may comprise one or more magnets 32 adapted to attach the magnet holder 30 and thus the current collector 20 to a wall member 10 as shown in FIG. 1. The magnet holder can have a receptacle 33 for the current collector 20, here in the form of a groove 33 provided on the magnet holder, which interacts with a corresponding tongue 27 of the current collector 20.

Optionally, the current collector 20 (especially in combination with the holder 30) can be adapted such that the contact needles 21a-d can be moved between a contact position, in which the contact needles can contact the electrical conductor tracks of the wall member, and a non-contact position, in which the contact needles are at a distance from the conductor tracks, when the current collector is placed on the current-carrying wall member. For this purpose, the current collector 20 may comprise a spring element 28, for example as shown in FIG. 14B and FIG. 15. The magnetic holder 30 may optionally further comprise a slot 33 for an electrical device. In this case, the electrical device can be adapted to contact the output pins or output contacts 24a, 24b for power supply in an inserted position. Optionally, the current collector 20 in combination with the holder 30 can be adapted to be moved from the non-contact position to the contact position by inserting an electrical device into the plug-in unit or groove 33.

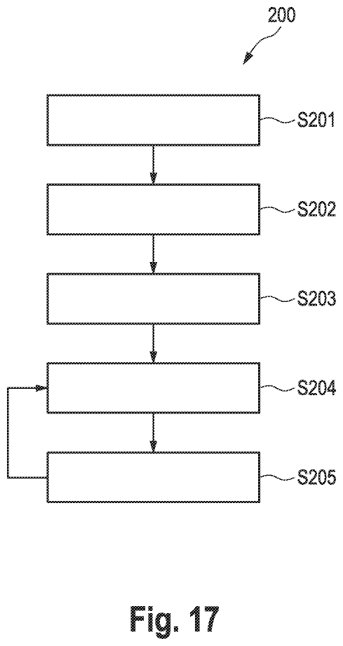

FIG. 17 shows a flow chart of a method 200, in particular for a presentation, sales or exhibition stand (100) and/or for store fitting. In a first step S201, a current-carrying wall member as described in the present disclosure is provided. In a second step S202, a current collector as described in the context of the present disclosure is provided. In a third step S203, the current collector is attached to the current-carrying wall member in such a way that a first of the contact needles contacts one of the first electrical conductor tracks and at least one other of the contact needles contacts one of the second electrical conductor tracks.

In an optional fourth step S204, a check of the position and rotation of the current collector (or of an electrical device comprising the current collector or connected to the current collector) can be performed. In an optional fifth step S205 a correction of the position and/or rotation of the current collector can be made. Steps S204 and S205 can optionally be repeated iteratively until a desired position and rotational alignment is reached. This can further improve the flexibility in the placement or design of such a presentation system. In particular, it is not necessary to define a position and angular alignment of the electrical consumers in advance, as they can be flexibly adjusted.

It shall be understood that the embodiments described herein as examples can also be used in modified form, for example with a different number of contact needles, different dimensions, different distances between contact needles and surfaces and/or modifications of the geometric arrangement, within the scope of the attached claims respectively.

It shall be understood that the shown strictly vertical or horizontal arrangement of the electrical conductor tracks, as shown in FIG. 2, is to be understood as an example, so that they can also be provided thinner, thicker, diagonally or in some other way such as e.g. circular or meandering on the carrier element 15. For the operation of the electrical device 5 the current collector can interact with the electrical conductor tracks arranged on the carrier element in such a way that at least a first contact needle can come into electrical contact with one of the first conductor tracks and a second contact needle with one of the second conductor tracks. For the power supply, in particular low-voltage systems can be used, which work with 12/24 V and can therefore be used without danger. However, by using special insulators which are applied as varnish, foil and/or other materials, it is also conceivable to use higher-voltage systems, i.e. systems operating at higher voltage, if necessary. Thanks to the e.g. needle-like design of the contacting needles, they can be moved frequently without damaging the cover. In general, the conductors 11, 12 usually carry low voltage, for example 12 or 24 V, so that the risk of injury when handling the proposed wall member 10 or the current collector 20 or an electrical device 5 connected to it can be almost completely excluded. The application of the conductor tracks 11, 12 on the carrier plate 15 can be done for example by spraying, gluing or welding. In particular, conductive lacquers can also be used for the conductor paths 11, 12 which are sprayed/printed (e.g. by screen printing) onto the carrier plate 15.

It is also possible that the wall members 10 may not only be made flat, but can also be curved or arched. Modern magnets 6 enable magnetic forces of considerably more than 80 kg, so that even large electrical devices 5 or electrical devices 5 arranged in special presentation elements, such as shelves 11 (see FIG. 1), can be easily mounted to the respective wall members 10.

The wall member 10 can also be designed flexibly, in particular it can be rolled up or down, so that it can for example be used as wallpaper or floor covering. The wall member 10 can be constructed as a sandwich material, which comprises the current-carrying conductors 11, 12 and can be used or mounted as wallpaper/carpet (rolled material) or panel material.

The sandwich construction can be done as follows: The cover 18 (surface material) is configured as a thin, penetrable, flexible material, behind this the conductor tracks 11, 12 are arranged on an insulating material, behind this there is the carrier material 15 made of plastic and/or of magnetic or magnetizable material, such as steel.

The current collector 20 and/or the electrical consumer 5 can also be intelligent or programmable. Data can be transmitted by modulating a signal on one or both of the electrical conductor tracks 11, 12 by means of so-called power line communication (PLC) or by wireless communication or optically. For example, different current collectors 20 and/or electrical devices 5 can be selectively controlled. For example, switching/dimming/controlling of individual devices 5 is possible. Furthermore, a bus system can also be provided in which the electrical conductors 11, 12, the current collectors 20 and/or the electrical devices 5 represent a part of the bus system and with which individual devices 5 can be individually addressed/controlled.

Optionally, a wall member can also be adapted to be applied under a wall covering, such as fiberglass wallpaper, and used for example in the field of smart home or in a museum. The current collectors can be used to supply electrical devices, such as lighting equipment for pictures or other exhibits or monitors explaining the exhibits, with electrical energy.

Likewise, the proposed system can be used in an office or a private home, where it can then be placed for example under a surface of textile, foil or wood veneer or other wall surface materials. By means of the current collectors it is possible to flexibly supply electrical devices at different positions and especially at different angles of rotation with electrical energy, without having to provide a multitude of possibly ugly power outlets. In particular when using a low-voltage system, the safety for children or other persons can be improved while at the same time providing increased flexibility.

1. A system, in particular for a presentation, sales or exhibition stand and/or for store fitting, the system comprising:
a current-carrying wall member and
a current collector for an electrical device, which is configured to be mounted on the wall member;
wherein the wall member comprises a carrier plate and a cover that covers the carrier plate;
wherein the wall member comprises first electrical conductor tracks of a first polarity and second electrical conductor tracks of a second polarity, wherein the first and second electrical conductor tracks are arranged alternately at least in sections;
wherein the current collector comprises a plurality of at least three contact needles,
wherein the current collector is adapted to be attached to the wall member such that at least one of the contact needles contacts one of the first electrical conductor tracks and at least one other of the contact needles contacts one of the second electrical conductor tracks; and
wherein a first contact needle, a second contact needle, and a third contact of said plurality of contact needles are arranged on a circle.

2. The system according to claim 1, wherein the first, the second and the third contact needle of the current collector are arranged in such a way that they form a triangle.

3. The system according to claim 2, wherein the first, the second and the third contact needle of the current collector are arranged in such a way that they form an isosceles triangle.

4. The system according to claim 2, wherein the first, the second and the third contact needle of the current collector are arranged in such a way that they form an equilateral triangle.

5. The system according to claim 1, wherein a diameter of the circle on which the first contact needle, the second contact needle and the third contact needle are arranged is less than or equal to the sum of a width of one of the first conductor tracks and a width of one of the second conductor tracks and a width of an insulation gap between them.

6. The system according to claim 1, wherein the contact needles of the current collector are arranged in such a way that, when the current collector is attached to the current-carrying wall member, at least a first of the contact needles is brought into contact with one of the first conductor tracks and a second contact needle is brought into contact with one of the second conductor tracks, independently of a rotation of the current collector on the current-carrying wall member.

7. The system according to claim 1, wherein the contact needles being arranged on a circle are arranged such that the first contact needle lies in a first third of the circle, the second contact needle lies in a second third of the circle, and the third contact needle lies in a third third of the circle.

8. The system according to claim 1, wherein the current collector further comprises a fourth, a fifth and a sixth contact needle and the first to sixth contact needles are arranged as a hexagon.

9. The system according to claim 1, wherein the current collector and the contact needles are arranged such that, when the current collector is attached to the wall member, at least two contact needles contact one or more of the first electrical tracks and at least two of the contact needles contact one or more of the second electrical tracks.

10. The system according to claim 1, wherein the contact needles are arranged such that a distance between the first contact needle and a straight line through the second contact needle and the third contact needle is greater than a width of one of the electrical conductor tracks.

11. The system according to claim 1, wherein the current collector comprises a fourth contact needle and the fourth contact needle is arranged within the circle on which the first, second and third contact needles are arranged.

12. The system according to claim 11, wherein the fourth contact needle is spaced apart decentered from a center of the circle.

13. The system according to claim 1, further comprising a rectifier adapted to provide an output voltage of defined polarity based on an input voltage applied to at least two of the contact needles.

14. The system according to claim 13, wherein the rectifier comprises at least three inputs and two outputs, each of the at least three inputs being connected to a corresponding contact needle.

15. The system according to claim 1, wherein the current collector is adapted such that the contact needles are movable between a contact position in which the contact needles contact the conductor tracks and a non-contact position in which the contact needles are separated from the conductor tracks when the current collector is attached to on the current-carrying wall member.

16. The system according to claim 1, wherein the current collector is adapted such that, when the current collector is aligned horizontally or vertically, a straight line through the first and second contact needles intersects a horizontal or vertical axis of the current collector at an acute angle.

17. The system according to claim 16, wherein the straight line through the first and second contact needles intersects the horizontal or vertical axis of the current collector at an angle of at least one of (a) not more than 30°, (b) not more than 15°, or (c) not more than 5°.

18. The system according to claim 16, wherein the straight line through the first and second contact needles intersects the horizontal or vertical axis of the current collector at an angle between than 5° and 10°.

19. The system according to claim 1, further comprising an electrical device on which the current collector is arranged in such a way that a straight line through the first and second contact needles intersects a horizontal or vertical axis of the electrical device at an acute angle when the electrical consumer is oriented horizontally or vertically.

20. The system according to claim 19, wherein the straight line through the first and second contact needles intersects a horizontal or vertical axis of the electrical device at an angle of at least one of (a) not more than 30°, (b) not more than 15°, or (c) not more than 5°, when the electrical consumer is oriented horizontally or vertically.

21. The system according to claim 19, wherein the straight line through the first and second contact needles intersects a horizontal or vertical axis of the electrical device at an angle between 5° and 10°, when the electrical consumer is oriented horizontally or vertically.

22. The system according to claim 1, wherein at least one of the contact needles is adapted such that a tip of the contact needle has an angle of at least one of (a) between 60° and 20°, (b) between 45° and 25°, or (c) of 30°.

23. The system according to claim 1, wherein the wall member and the current collector are adapted such that the current collector can he magnetically attached to the wall member.

24. A current collector for an electrical device in a system according to claim 1, the system being in particular a system for a presentation, sales or exhibition stand and/or for store fitting, the system comprising a current-carrying wall member;
wherein the wall member comprises a carrier plate and a cover that covers the carrier plate;
wherein the wall member comprises first electrical conductor tracks of a first polarity and second electrical conductor tracks of a second polarity, wherein the first and second electrical conductor tracks are arranged alternately at least in sections;
wherein the current collector is a current collector for an electrical device adapted to be mounted on the wall member;
the current collector having a plurality of at least three contact needles,
wherein the current collector is adapted to be attached to the wall member such that at least one of the contact needles contacts one of the first electrical conductor tracks and at least one other of the contact needles contacts one of the second electrical conductor tracks; and
wherein a first contact needle, a second contact needle, and a third contact needle of said plurality of contact needles are arranged on a circle:

25. (canceled)

26. A method for a presentation, sales or exhibition stand and/or for store fitting, the method comprising the steps:
providing a current-carrying wall member;
providing a current collector for an electrical device, which is configured to be mounted to the wall member;
wherein the wall member comprises a carrier plate and a cover that covers the cover plate;
wherein the wall member comprises first electrical conductor tracks of a first polarity and second electrical conductor tracks of a second polarity, wherein the first and second electrical conductor tracks are arranged alternately at least in sections;
wherein the current collector has a plurality of at least three contact needles,
wherein the current collector is adapted to be attached to the wall member such that at least one of the contact needles contacts one of the first electrical conductor tracks and at least one other of the contact needles contacts one of the second electrical conductor tracks; and
wherein a first contact needle, a second contact needle, and a third contact needle of said plurality of contact needles are arranged on a circle; and
attaching the current collector to the current-carrying wall member such that a first of the contact needles contacts one of the first electrical conductor tracks and at least one other of the contact needles contacts one of the second electrical conductor tracks.
